(19) United States
(12) Patent Application Publication
(10) Pub. No.: US 2026/0126996 A1
(43) Pub. Date: May 7, 2026

(54) DATA PREFETCHING BASED ON BOTH INTRA-TILE AND INTER-TILE STRIDE INFORMATION

(71) Applicant: Intel Corporation, Santa Clara, CA (US)

(72) Inventors: Stijn Eyerman, Evergem (BE); Wim Heirman, Aalter (BE)

(73) Assignee: Intel Corporation, Santa Clara, CA (US)

(21) Appl. No.: 18/936,381

(22) Filed: Nov. 4, 2024

(51) Int. Cl. G06F 9/22; G06F 9/26

(52) U.S. Cl. CPC G06F 9/226; G06F 9/261; G06F 9/265

(57) ABSTRACT

Techniques and mechanisms for tile prefetching to be performed based on both intra-tile stride characteristics and inter-tile stride characteristics. In an embodiment, a prefetch circuit of a processor core detects that multiple demand fetch instructions target different respective tiles of a matrix. Based on the multiple demand fetch instructions, fetch pattern information is registered and made available for future reference to facilitate detection of a later instance of the fetch pattern. Fetch pattern information corresponding to a first demand fetch instruction comprises both an inter-tile stride and an inter-tile stride. In another embodiment, the prefetch circuit generates micro-operations, based on the fetch pattern information, to prefetch one or more tiles of the matrix.

### BACKGROUND

### 1. Technical Field

This disclosure generally relates to matrix multiplication and more particularly, but not exclusively, to a tile prefetcher which operates based on a various types of tile strides.

### 2. Background Art

General matrix multiplication (GEMM) is an important functionality for various technologies, such as generative large language models (LLM) and various other artificial intelligence (AI) models. Such models often comprise multiple fully connected layers with different dimensions, which are implemented using GEMMs. In many instances, GEMMs are interspersed with non-linear functions, but the overall execution time is largely dominated by the GEMMs. Some models, such as image generating diffusion models, use convolution layers, that can also be implemented using GEMMs.

As successive generations of artificial intelligence technologies continue to increase in number, variety, and capability, there is expected to be an increasing premium placed on improvements to the efficiency of GEMM performance.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system to facilitate tile prefetching according to one embodiment.

FIG. 2 shows a flow diagram illustrating features of a method to access stride information which facilitates tile prefetching according to an embodiment.

FIG. 3 shows a block diagram illustrating features of a core to perform tile prefetching based on different types of stride information according to an embodiment.

FIG. 4 shows a data diagram illustrating operations of a matrix multiplication using tiles which are prefetched according to an embodiment.

FIG. 5 shows a format diagram illustrating features of a fetch pattern table to provide various types of stride information according to an embodiment.

FIG. 6 shows a format diagram illustrating features of a prefetch table to identify prefetch operations performed according to an embodiment.

FIG. 7 illustrates an exemplary system.

FIG. 8 illustrates a block diagram of an example processor that may have more than one core and an integrated memory controller.

FIG. 9A is a block diagram illustrating both an exemplary in-order pipeline and an exemplary register renaming, out-of-order issue/execution pipeline according to examples.

FIG. 9B is a block diagram illustrating both an exemplary example of an in-order architecture core and an exemplary register renaming, out-of-order issue/execution architecture core to be included in a processor according to examples.

FIG. 10 illustrates examples of execution unit(s) circuitry.

FIG. 11 is a block diagram of a register architecture according to some examples.

### DETAILED DESCRIPTION

Embodiments discussed herein variously provide techniques and mechanisms for tile prefetching to be performed based on both intra-tile stride characteristics and inter-tile stride characteristics. The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a tile prefetcher.

The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

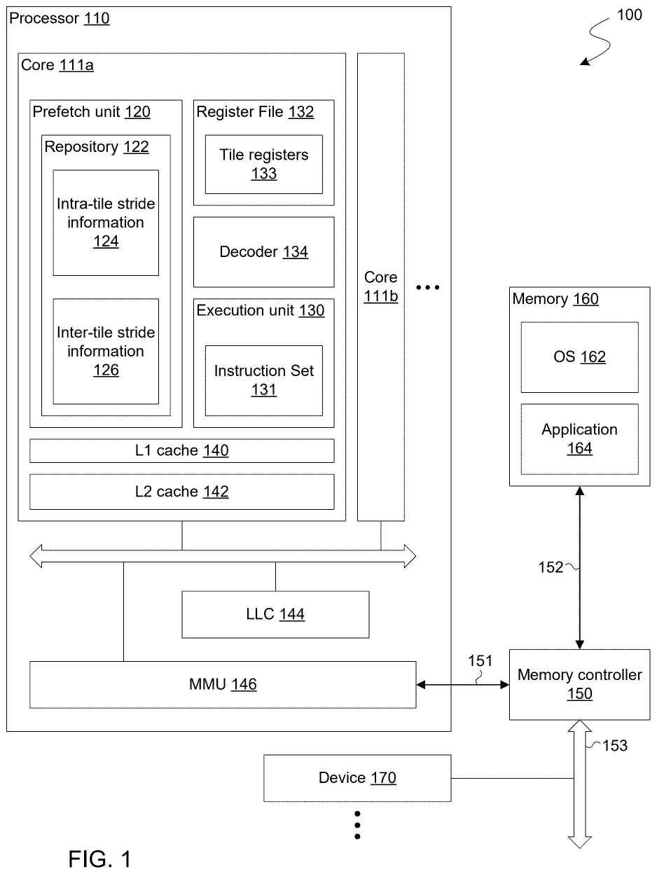

FIG. 1 is a block diagram illustrating a system 100 that facilitates a prefetching of tiles according to one embodiment. System 100 is one example of an embodiment which makes a repository of stride information available for use in determining whether—and if so, how—one or more tiles are to be prefetched to facilitate a matrix multiplication. System 100 includes, or supports operation in, any of various computing devices including handheld devices and devices for embedded applications. For example, system 100 provides or is to operate as a component of any of various devices including, but not limited to, a desktop computer, a tablet computer, a laptop computer, a netbook, a notebook computer, a personal digital assistant (PDA), a server, a workstation, a cellular telephone, a mobile computing device, a smart phone, an Internet Protocol device, a digital camera or the like. In some embodiments, some or all of system 100 is implemented in a system on a chip (SoC).

As shown in FIG. 1, system 100 comprises a processor 110, a memory controller 150, and a memory 160 which are variously couple to one another—e.g., via the illustrative processor bus 151, memory bus 152, and fabric 153 shown. Memory 160 is coupled to support operation as a main memory of system 100—e.g., wherein one or more regions of memory 160 are variously allocated each to provide the state of a respective software process which is executed with processor 110.

One embodiment is described in the context of a single processor desktop or server system, but alternative embodiments are included in a multiprocessor system. Processor 110, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 110 is coupled to processor bus 151, which transmits data signals between the processor 110 and another component in system 100, such as memory controller 150, for storing data, address information and/or the like.

Processor 110 comprises one or more processor cores (including the illustrative cores 111a, 111b shown) to execute instructions of system 100. The core 111a includes, but is not limited to, a prefetch unit 120 to fetch data (and, in some embodiments, instructions), decoder 134 to decode the instructions, an execution unit 130 to execute instructions and the like. A register file 132 of core 111a is to store different types of data in registers including, but not limited to, integer registers, floating-point registers, vector registers, banked registers, shadow registers, checkpoint registers, status registers, configuration registers, instruction pointer register, and/or the like.

In various embodiments, processor 110 includes one or more caches to cache instructions and/or data. For example, such one or more caches include, but are not limited to, level one, level two, and a last level cache (LLC), or any other configuration of cache memory within processor 110. Depending on the architecture, the processor 110 has a single internal cache or multiple levels of internal caches. In various embodiments, system 100 includes a combination of one or more caches which are internal to processor 110, and one or more caches which are external to processor 110.

In an illustrative scenario according to one embodiment, core 111a includes one or more caches that are arranged in a cache hierarchy. By way of illustration and not limitation, such a hierarchy includes a level 1 (L1) cache 140, and level 2 (L2) cache 142 that, in some embodiments, is to function as a mid-level cache (MLC). In some embodiments, the L1 cache 140 is comprised of an instruction cache for storing instructions and/or a data cache for storing the data needed for executing the instructions.

In various embodiments, processor 110 further includes a last level cache (LLC) 144—e.g., a level 3 (L3) cache—that is communicatively coupled to, and shared by, all the cores 111. In some embodiments, the LLC 144 is physically distributed and logically shared among the cores 111. Each of L1 cache 140, L2 cache 142, and LLC cache 144, according to one embodiment, is managed by a respective cache agent or controller and is usable for caching data (and, for example, instructions).

In one example, core 111a comprises a floating-point unit. In another example, processor 110 does not have a floating-point unit. The processor 110, in one embodiment, includes a microcode (ucode) ROM to store microcode, which when executed, is to perform algorithms for certain macroinstructions or handle complex scenarios. Here, microcode is potentially updateable to handle logic bugs/fixes for processor 110.

Memory 160 illustrates any of a variety of one or more memory devices which are to provide some or all of a main memory of system 100. In an illustrative scenario according to one embodiment, various partitions and/or other allocated regions of memory 160 are setup, for example, at boot time by a basic input-output system (BIOS). Alternatively, processor 110 executes instructions of an operating system (OS), a virtual machine monitor (VMM) or other software agent which provides functionality to initialize, modify or otherwise determine an allocation of memory resources.

In an embodiment, processor 110 is coupled to (or alternatively, includes) a memory controller 150 which is to perform functions that enable processor 110 to access and communicate with memory 160. Memory 160 comprises random access memory (RAM) in a fixed or removable format. RAM includes volatile memory configured to hold information during the operation of system 100 such as, for example, static RAM (SRAM) or Dynamic RAM (DRAM). In some embodiments, memory controller 150 performs one or more operations which, for example, are adapted from conventional techniques for providing a processor with access to a main memory. Such conventional techniques are not detailed herein to avoid obscuring certain features of various embodiments which are not limited to said techniques.

In the example embodiment shown, a memory management unit (MMU) 146 of processor 110 provides functionality to manage access, via memory controller 150, to various regions of memory 160 by one or more processes which are executed with core 111a (and/or with one or more other cores of processor 110). By way of illustration and not limitation, MMU 146 determines an allocation of one or more pages in memory 160 to a given process, and (for example) configures a page table comprising page table entries each for a corresponding page of the process. For a given one of such page entries, the page table entry maps a physical address for the corresponding page to a virtual address for the corresponding page.

In one such embodiment, MMU 146 supports the implementation of a virtual address space, addresses of which are each to be mapped to a corresponding address in a physical address space. For example, software executed with processor 110 variously references or otherwise uses virtual addresses, which MMU 146 translates into respective physical addresses for use in accessing corresponding pages of memory 160. In an embodiment, MMU 146 includes or otherwise has access to a translation lookaside buffer (or “TLB”, not shown) which provides a cache of recently accessed page table entries. In various embodiments, some or all operations by MMU 146 are adapted, for example, from conventional memory map techniques and/or mechanisms.

In an illustrative scenario according to one embodiment, core 111a executes an operating system (OS) 162 which, for example, includes or otherwise supports execution of one or more other software processes. In addition, one or more applications (including the illustrative application 164, for example) are executed with OS 162—e.g., wherein application 164 includes, or operates with, another driver process which facilitates operation of one or more devices (e.g., including the illustrative device 170 shown). By way of illustration and not limitation, implementation of OS 162, application 164, and/or other such software process includes execution unit 130 variously executing instructions of an instruction set 131.

Device 170 illustrates any of a variety of one or more endpoint devices, including a bus, or other endpoint hardware. In one embodiment, the one or more devices includes one or more integrated devices (e.g., integrated with some or all of processor 110, and memory 160) such as processor graphics. Alternatively or in addition, the one or more devices includes one or more discrete devices (such as PCIe™ devices or other attached devices), one or more legacy devices that do not support shared virtual memory, and/or the like. In one illustrative embodiment, the one or more devices includes one or more network controller devices, storage controller devices, peripheral controller devices (like Universal Serial Bus (USB) controllers), media controller devices, display controllers, and/or the like.

In various embodiments, execution of OS 162, application 164 and/or any of various other software processes includes, is based on, results in, or is otherwise associated with, the performance of a matrix multiplication with execution unit 130. To improve the efficiency of matrix multiplication, several processor architectures have adapted matrix extensions, which are similar functionally to previously-introduced vector extensions. For example, Intel Corporation of Santa Clara, California has provided the Advanced Matrix Extensions (AMX) in the 4th generation Xeon architecture. Furthermore, Arm Holdings of Cambridge, England provided the Scalable Matrix Extensions (SME) in its Armv9-A architecture. Further still, International Business Machines Corporation (IBM) of Armonk, New York provided the Matrix Multiply Assist (MMA) in its IBM Power10 architecture. Certain features of various embodiments are described with respect to functionality which supplements that of Intel's AMX technology. It is to be appreciated that such description can be extended to embodiments which additionally or alternatively supplement any of various other matrix extension technologies.

In an illustrative scenario according to one embodiment, a register file, such as register file 132, includes multiple registers—e.g., the 8 matrix registers provided with AMX—which are available each to receive a respective portion of matrix data (where such a portion is referred to herein as a “tile”). By way of illustration and not limitation, each such tile holds up to 16 rows, with 64 byte of data per row that (for example) can be interpreted as 16 4-byte elements (FP32), 32 2-byte elements (BF16) or 64 1-byte elements (INT8). In various embodiments, each such tile corresponds to a 16 by 16/32/64 block of a matrix, and holds 1 KB of data. The number of active rows in a given tile are (re)configurable to be between 1 and 16—e.g., depending on the dimensions of the matrix.

In one such embodiment, in addition to dedicated registers (such as the illustrative tile registers 133 shown), a given core has a systolic array functional unit or other suitable circuitry (e.g., at execution unit 130) that performs matrix multiplication of 2 tiles and adds the result to the destination tile. For example, a corresponding tile multiplication (TMUL) instruction of instruction set 131 supports two input data types: BF16 and INT8, corresponding respectively to a 16×32×32×16 and a 16×64×64×16 matrix multiplication (if all rows of both tiles are active). Both variants output a 16×16 FP32 tile. To support the ‘transposed’ dimensions of a right (B) matrix, each 32-bit element is interpreted as 2 BF16 or 4 INT8 elements of different rows, packing 2 or 4 matrix rows in one 64 B tile row.

A given tile of data corresponds to a two-dimensional (2D) rectangular block of data in a matrix. To load and store tile data to and from a register, instruction set 131 includes, or supports operation with, a tile load instruction (tileload) and/or a tile store instructions (tilestore)—e.g., as provided with AMX. In one such embodiment, each tile memory instruction reads or writes up to 16 cache lines of data, depending on the number of active rows of the corresponding tile register. However, in many instances, cache lines corresponding to the tile in question are often subject to being in non-successive locations in a memory resource.

As with many data access use cases, tile fetching is often subject to bursty access, queueing delays and/or various other performance limitations. As just one example, the use of a single tileload instruction to load multiple (e.g., 16) cache lines can result in an overload or other bursty usage of a queue, a bus and/or the like. To mitigate the risk of such performance limitations, some embodiments variously facilitate an efficient prefetching of tile data based on fetch pattern information which includes both one or more intra-tile stride characteristics and one or more inter-tile stride characteristics.

As used herein, the term “intra-tile stride” (or, for brevity, merely “intra-stride”) refers to a stride between two successive data portions in the same tile, wherein “successive” in this particular context is with respect to an order in which portions of the tile in question are to be fetched (e.g., loaded), stored or otherwise accessed. Where such an order is based on a tileload instruction (for example), an intra-tile stride is alternatively referred to as an “intra-tileload stride”. By contrast, “inter-tile stride” (or, for brevity, merely “inter-stride”) refers herein to a stride between two successive data portions in different respective tiles. Where such data portions are fetched based on different respective—and successive—tileload instructions (for example), an inter-tile stride is alternatively referred to as an “inter-tileload stride”.

Conventional prefetcher hardware usually has difficulty in consistently prefetching tile data in a timely manner. For example, some existing prefetchers tend to have high accuracy (few incorrect prefetches), but low timeliness (more than half of the prefetches are issued too late). In a typical scenario, such low timeliness is caused at least in part by tileload instructions—e.g., wherein the prefetcher detects the intra-stride pattern in a tileload and starts issuing prefetches for that tileload. However, the next demand loads of that tileload instruction are often issued soon after, meaning that the issued prefetches do not help much. Furthermore, contention in a tag directory (TD contention) is often a risk in cases where demand loads and prefetches are close to each other in time and target the same cache line.

Instead of prefetching data of the same tileload, some embodiments variously commence the prefetching of data for one or more tileloads that are expected to be issued further into the future, making the prefetches more timely and less contending. For example, some embodiments variously improve upon conventional prefetchers by identifying and exploiting one or more fetch patterns which each comprise a respective two dimensions of stride characteristics—i.e., a stride within a given tile, and a stride between said given tile and another tile. In providing a tile-aware prefetcher that is able to differentiate between an internal tile stride and one or more inter-tile strides, some embodiments variously facilitate time efficient and hardware efficient loading of tiles for GEMM.

In various embodiments, core 111a comprises circuitry to detect one or more characteristics of a pattern according to which one or more tiles are accessed using, for example, one or more tileload instructions (or other suitable demand fetch instructions). In one such embodiment, such fetch pattern information (e.g., including one or more intra-tile stride characteristics, and also one or more inter-tile stride characteristics) is kept in a registry for later use as a reference to determine, for example, whether a subsequently detected stream is to target the same one or more tiles. In this particular context, the term “stream” refers herein to a sequence of instructions or micro-operations—which are to be executed and/or are being executed—to retrieve data of a given matrix. For example, a “fetch stream” refers more particularly to a sequence of demand fetch instructions, whereas “prefetch stream” refers more particularly to a sequence of micro-operations (“micro-operations”) to prefetch tile data.

Important prefetcher metrics are accuracy, coverage and timeliness. Accuracy corresponds to the fraction of prefetched data that is eventually requested by a processor core (such as core 111a). An inaccurate prefetcher issues useless prefetches that waste memory bandwidth and take cache space, potentially evicting useful cache lines. Coverage corresponds to the fraction of cache misses that are avoided by the prefetcher. A prefetcher that issues very few prefetches can be highly accurate, but it will also have low coverage, resulting in almost no performance benefit. Often, accuracy and coverage are opposing forces: a very aggressive prefetcher issues many prefetches, reducing its accuracy but improving its coverage, and vice versa for a more cautious prefetcher that focuses on accuracy. Timeliness corresponds to the fraction of useful prefetches that were prefetched long enough ahead such that their data is cached when the request from core 111a is issued, minimizing the access latency for core 111a. Accurate prefetches that are still in transfer at the time the data is requested by core 111a are called pending prefetches. They also reduce latency compared to a cache miss, because the data is already on the way, but they would have been more beneficial to performance if issued earlier.

In the example embodiment shown, core 111a further comprises a prefetch unit 120 which includes a controller, an application specific integrated circuit (ASIC), a state machine, and/or any of various other suitable types of integrated circuitry which are configured to detect patterns in one or more memory access streams, to register one or more such patterns, and to determine, based on the one or more registered fetch pattern, whether a subsequent memory access stream exhibits any registered fetch pattern. Based on such a determination, prefetch unit 120 generates one or more signals (e.g., outputs one or more micro-operations) to prefetch one or more tiles which are expected to be targeted by the subsequent memory access stream.

By way of illustration and not limitation, prefetch unit 120 includes, is coupled to, or otherwise operates based on, one or more repositories (such as the illustrative repository 122 shown) with which fetch pattern information is to be registered for later reference in the determination of whether—and if so, how—tile data of a later stream is to be prefetched. In an embodiment, repository 122 is to register both intra-tile stride information 124 and inter-tile stride information 126 which (for example) is based on a detected fetch stream. Using the registered intra-tile stride information 124 and inter-tile stride information 126, prefetch unit 120 determines whether—according to some predefined criteria—a subsequent stream sufficiently satisfies a registered fetch pattern. Based on such a determination, prefetch unit 120 generates one or more signals (e.g., provides one or more micro-operations) which, directly or indirectly, cause execution unit 130 to prefetch tile data from a memory resource to a cache of core 111a.

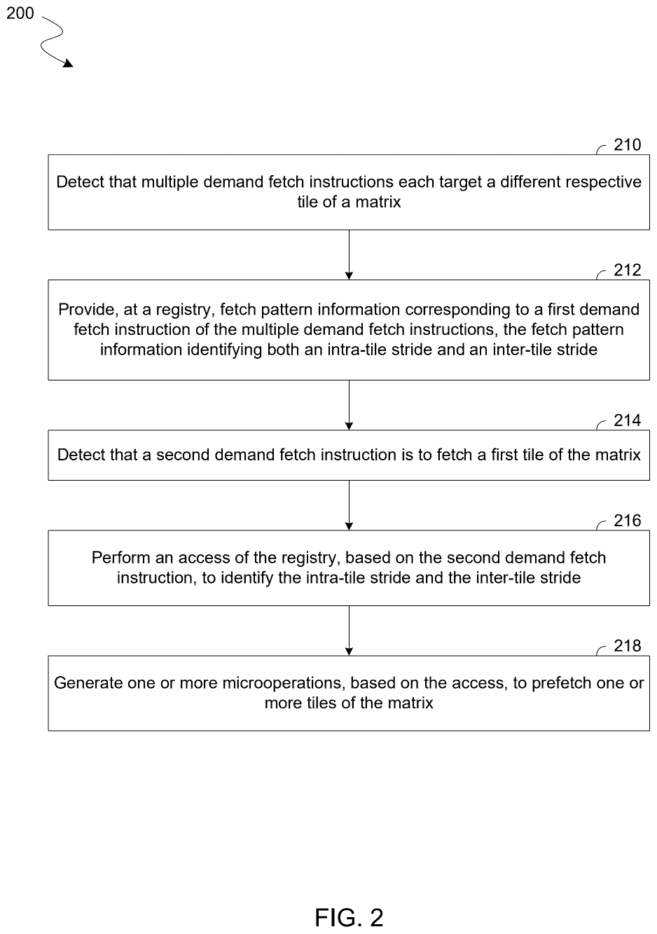

FIG. 2 shows a method 200 for accessing stride information which facilitates tile prefetching according to an embodiment. Method 200 illustrates one example of an embodiment wherein demand fetch pattern information is registered and utilized as a basis for determining that a subsequent stream of tile data can be prefetched. Operations such as those of method 200 are performed with any of various combinations of suitable hardware (e.g., circuitry), firmware and/or executing software which, for example, provide some or all of the functionality of prefetch unit 120.

As shown in FIG. 2, method 200 comprises (at 210) detecting one or more events wherein multiple demand fetch instructions each target a different respective tile of a matrix. In various embodiments, the detecting at 210 comprises determining that respective operands of the multiple demand fetch instructions (tileload instructions, for example) each directly or indirectly identify a respective tile of the same matrix as a fetch target.

Based on the detecting at 210, method 200 (at 212) provides fetch pattern information at a registry based on the one or more events—e.g., wherein repository 122 is to provide said registry. The fetch pattern information corresponds to a first demand fetch instruction of the multiple demand fetch instructions, wherein the fetch pattern information identifies both an intra-tile stride and an inter-tile stride. It is to be appreciated that at least two demand fetch instructions are to be detected at 210, so that an (inter-tile) stride between a given pair of said at least two demand fetch instructions can be registered at 212.

For example, the providing at 212 includes or is otherwise based on prefetcher circuitry determining that the first demand fetch instruction includes an operand that specifies an intra-tile stride for a targeted tile of the matrix. Additionally or alternatively the prefetcher circuitry determines an inter-tile stride—e.g., by calculating or otherwise identifying a difference between respective locations (e.g., between the respective base addresses) of the first demand fetch instruction, and of another demand fetch instruction of the multiple demand fetch instructions. In one such embodiment, the providing at 212 further includes, or is otherwise based on, the prefetcher circuitry determining another inter-tile stride based on a difference between respective locations of the first demand fetch instruction, and of still one more demand fetch instruction of the multiple demand fetch instructions.

In various embodiments, a prefetcher creates an entry of the registry at 212, and provides the fetch pattern information to said entry—e.g., wherein the entry is to include, be indexed by, or otherwise associated with an identifier of the first demand fetch instruction. By way of illustration and not limitation, such an identifier includes, or is otherwise based on, a base address of the first demand fetch instruction, and/or on an instruction pointer value which corresponds to the first demand fetch instruction. In one such embodiment, the entry comprises one field to identify the intra-tile stride based on an operand of the first instruction. Furthermore, the entry comprises another field to identify the inter-tile stride based, for example, on respective base addresses of the first demand fetch instruction and another of the multiple demand fetch instructions. In some embodiments, the entry further comprises one or more additional fields each to identify a respective inter-tile stride which corresponds to the first demand fetch instruction and to a different respective other one of the multiple demand fetch instructions.

After the registering of the fetch pattern information at 212, method 200 (at 214) detects that a second demand fetch instruction (subsequent to the multiple demand fetch instructions) is to fetch a first tile of some version—e.g., the same version, or in other embodiments, a modified version—of the matrix which was previously targeted by the multiple demand fetch instructions. Based on the detecting at 214, method 200 (at 216) performs an access of the registry to identify the intra-tile stride and the inter-tile stride. Based on the access performed at 216, method 200 (at 218) generates one or more microoperations to prefetch one or more tiles of the matrix.

For example, the generating of the one or more microoperations at 218 comprises providing stream information at a second registry (e.g., the prefetch registry 342 described herein) based on the second instruction, and generating the one or more microoperations according to the stream information. In an embodiment, the stream information corresponds to the one or more tiles of the matrix, and comprises the intra-tile stride and the inter-tile stride.

In one such embodiment, the stream information is provided at an entry of the second registry, which (for example) method 200 subsequently updates based on a determination that a third demand fetch instruction targets data of the one or more tiles, wherein the third demand fetch instruction is subsequent—e.g., immediately or otherwise—to the second demand fetch instruction. For example, based on the third demand fetch instruction, the entry is updated to replace one base address (e.g., corresponding to the second demand fetch instruction) with another base address which corresponds to the third demand fetch instruction. In one such embodiment, the entry of the second registry comprises a field which identifies a maximum number of rows of a tile which is currently a target of a stream to which that entry corresponds. Alternatively or in addition, the entry of the second registry comprises another field which indicates, for such a targeted tile, a number of rows of the tile which remain to be prefetched. Alternatively or in addition, the entry of the second registry comprises another field which indicates a distance, relative to a location indicated by a base address, of a location from which data of the targeted tile has already been prefetched.

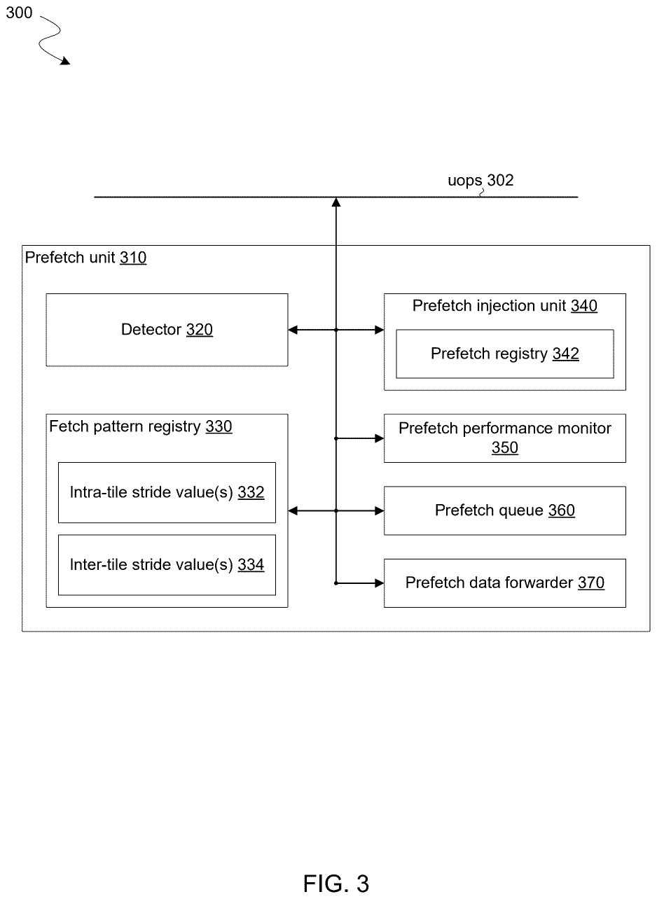

FIG. 3 shows a core 300 which performs tile prefetching based on different types of stride information according to an embodiment. Core 300 illustrates features of one example embodiment which provides functionality to detect an instruction to fetch a tile of a matrix, and to request tile prefetches based on the instruction and previously-registered fetch pattern information. For example, such fetch pattern information specifies or otherwise indicates both an intra-tile stride and an inter-tile stride. In some embodiments, core 300 provides functionality such as that of core 111a—e.g., wherein operations of method 200 are performed with some or all of core 300.

As shown in FIG. 3, core 300 comprises a prefetch unit 310 which (for example) provides functionality such as that of prefetch unit 120. Prefetch unit 310 comprises a detector 320, a fetch pattern registry 330, and a prefetch injection unit 340. In the example embodiment shown, prefetch unit 310 further comprises (for example) a prefetch performance monitor 350, a prefetch queue 360, and/or prefetch data forwarder 370. In various other embodiments, prefetch unit 310 omits some or all of prefetch performance monitor 350, prefetch queue 360, and prefetch data forwarder 370

In some embodiments, detector 320 is coupled to receive, intercept or otherwise detect demand fetch instructions which (for example) are decoded for execution at core 300. In one such embodiment, detector 320 is coupled to snoop one or more micro-operations (for example, in at least one micro-operation stream 302) which are generated by such instruction decoding—e.g., wherein micro-operations 302 are communicated between decoder 134 and execution unit 130.

In an embodiment, integrated circuitry of detector 320 is configured to identify a matrix which is targeted by a given demand fetch instruction (e.g., a tileload instruction). For example, detector 320 detects that one or more demand fetch instructions target different respective tiles of the same matrix. Although some embodiments are not limited in this regard, detector 320 further provides functionality to determine one or more dimensions (e.g., including a total number of rows and/or a total number of columns) of a given matrix which is targeted by one or more demand fetch instructions.

Based on such one or more demand fetch instructions, detector 320 identifies various strides each between a respective two portions of tile data in a targeted matrix. For example, detector 320 is operable to detect an “intra-tile” stride between different respective portions of the same tile. By way of illustration and not limitation, detector 320 provides functionality to determine an operand of a demand fetch instruction, wherein said operand explicitly identifies such an intra-tile stride. Alternatively or in addition, detector 320 determines an intra-tile stride by calculating a difference between base addresses which each indicate a different respective portion (e.g., a different respective row) of the same tile.

In various embodiments, detector 320 is operable to further detect one or more “inter-tile” strides each between a respective two different tiles of the same matrix. In one such embodiment, detector 320 identifies based on micro-operations which target different respective tiles of the same matrix, a difference between memory locations from which respective portions of two tiles are to be loaded.

In an embodiment, detector 320 registers to one or more repositories—e.g., to the illustrative fetch pattern registry 330 shown—fetch pattern information which, for a given matrix, comprises (for example) a respective one or more intra-tile stride values 332, and a respective one or more inter-tile stride values 334. In an embodiment, detector 320 (or other suitable circuitry of prefetch unit 310) is further operable to identify a currently active stream as conforming, in one or more respects, to a registered fetch pattern. For example, detector 320 identifies at least one access characteristic of one or more demand fetch instructions, and determines that at least one access characteristic is already registered at fetch pattern registry 330.

Where it is determined that a currently active stream conforms to one or more previously-registered access characteristics, detector 320 directly or indirectly indicates—e.g., to prefetch injection unit 340 of prefetch unit 310—that tile prefetching can be performed according to said one or more access characteristics. In the example embodiment shown, prefetch injection unit 340 includes, is coupled to, or otherwise operates based on, a prefetch registry 342 which, for example, identifies one or more streams for which prefetching is to be performed (and, in some embodiments, is currently being performed).

Responsive to detector 320, prefetch injection unit 340 creates in prefetch registry 342 an entry which identifies information—e.g., including a base address, an intra-tile stride, and an inter-tile stride—with which prefetch injection unit 340 generates micro-operations to prefetch tiles which are expected to be targeted by a corresponding stream.

Although some embodiments are not limited in this regard, prefetch unit 310 further comprises one or more other resources which facilitate the prefetching of tile data. By way of illustration and not limitation, prefetch unit 310 further comprises a prefetch performance monitor 350 which determines one or more performance metrics (e.g., including an accuracy metric, a coverage metric, a timeliness metric, and/or the like) and which, for example, selectively (re)configures one or more prefetch parameters based on said one or more performance metrics. In one such embodiment, prefetch performance monitor 350 updates a (re)configurable maximum number p of one or more cache lines which can be prefetched at a time (where p is a positive integer).

Alternatively or in addition, prefetch unit 310 further comprises a prefetch queue 360 which, for example, is to temporarily retain micro-operations which are generated by prefetch injection unit 340—e.g., prior to such micro-operations being injected into the stream of micro-operations 302. In some embodiments, prefetch unit 310 additionally or alternatively comprises a prefetch data forwarder 370 which is coupled to receive prefetched tile data—e.g., wherein the prefetched tile data is temporarily retained at prefetch data forwarder 370 until a destination cache is available.

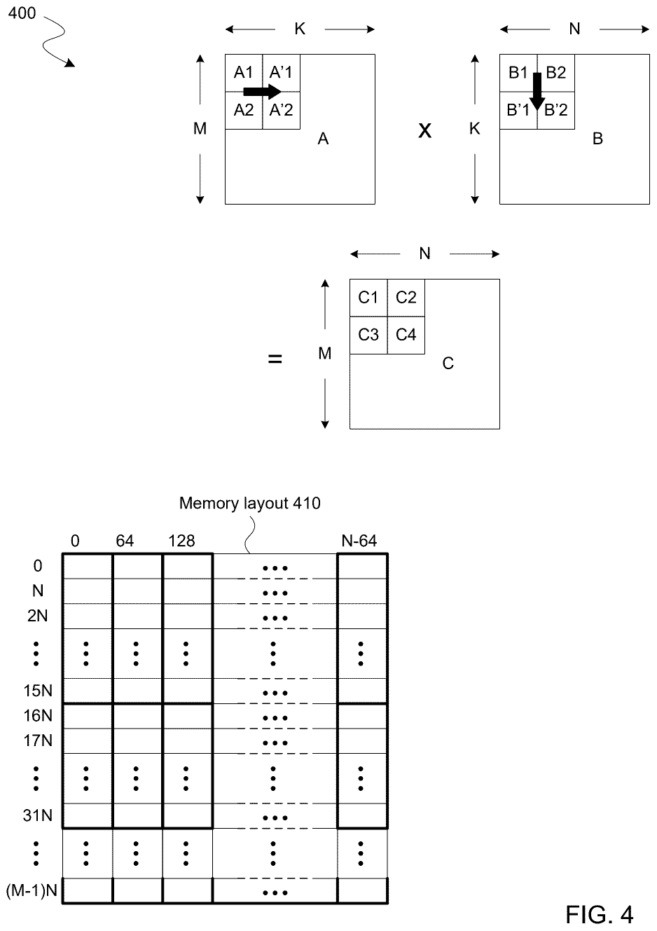

FIG. 4 shows operations of a matrix multiplication 400 which uses one or more tiles that have been prefetched according to an embodiment. Matrix multiplication 400 illustrates one example embodiment wherein some or all tile data of two matrices—i.e., including a matrix A and a matrix B—is fetched (or prefetched) according to a fetch pattern which is to be registered (or has been previously registered). In an embodiment, tile data which is accessed for matrix multiplication 400 determines, or is based on, fetch pattern information which is provided with prefetch unit 120 or prefetch unit 310—e.g., wherein matrix multiplication 400 includes, or is based on, operations of method 200.

As shown in FIG. 4, a matrix A includes at least four tiles A1, A′1, A2, A′2, and another matrix B includes at least four tiles B1, B′1, B2, B′2, wherein matrix multiplication 400 multiplies matrices A, B to calculate a third matrix C which includes at least four tiles C1, C2, C3, C4. Matrices are commonly stored in row order, and because matrices often have more than 32 or 64 columns (for example), a given tile in such a matrix—e.g., larger than a 16-by-32 matrix or a 16-by-64 matrix—is usually not stored in consecutive cache lines, as exemplified by the illustrative memory layout 410 shown.

To accommodate such cases, various types of demand fetch (e.g., tileload) instructions comprise an operand to indicate a configurable intra-tile stride—e.g., along with another operand to identify a base address for a line from which a beginning portion of the tile data is to be fetched. In one such embodiment, a tileload instruction specifies that a first cache line (e.g., corresponding to a first row in the tile) is to be loaded from a location which is identified by the base address, that a second cache line is to be loaded from a location which is identified by a sum of the base address and the intra-tile stride, that a third cache line is to be loaded from a location which is identified by a sum of the base address plus twice (two times) the intra-tile stride, etc. until a last row of the tile is fetched. The intra-tile stride is set to size of a row in the original matrix, resulting in fetching a consistent tile (block) of the matrix. For example, the intra-tile stride of a tile memory layout 410 is the positive integer N.

In the illustrative matrix multiplication 400 shown, respective tiles of matrix A and matrix B are variously multiplied with each other to determine respective tiles of the resulting matrix C. To facilitate efficient (re)use of matrix C, two respective tiles of matrix A and matrix B are selected such that they map to the same matrix C tile, after which they are multiplied and (for example) added to intermediate C tiles. Accordingly, a given matrix A tile is moved in row order (to the right, as shown in FIG. 4) and a given matrix B tile is moved in column order (downwards, as shown in FIG. 4). Subsequently, matrix multiplication moves on to calculate a next C tile—e.g., either by moving one tile down in matrix A (and reusing the matrix B tiles) or moving one tile to the left in matrix B (and reusing the matrix A tiles).

In an illustrative scenario according to one embodiment, matrix A has dimensions m×k, matrix B has dimensions k×n and matrix C has dimensions m×n, and {m, n, k} elements are {M, N, K} bytes (e.g., M=2m for BF16 elements or M=m for INT8). To facilitate one iteration of matrix multiplication 400, the address values to use for fetching a tile A1 of matrix A are calculated as (A+0), (A+K), (A+2K), (A+3K), . . . , (A+15K). Furthermore, the address values to use for fetching a tile A2 of matrix A are calculated as (A+16K), (A+17K), (A+18K), . . . , (A+31K). Further still, the address values to use for fetching a tile B1 of matrix B are calculated as (B+0), (B+N), (B+2N), . . . , (B+15N)—e.g., wherein the address values to use for fetching a tile B2 of matrix B are calculated as (B+64), (B+64+N), (B+64+2N), . . . , (B+64+15N).

In a next iteration of matrix multiplication 400, the matrix A tiles have been shifted to the right, and the matrix B tiles have been shifted downwards. To facilitate this next iteration of matrix multiplication 400, the address values to use for fetching the tile A′1 of matrix A are calculated as (A+64), (A+64+K), (A+64+2K), . . . , (A+64+15K). Furthermore, the address values to use for fetching the tile A′2 of matrix A are calculated as (A+64+16K), (A+64+17K), . . . , (A+64+31K). Further still, the address values to use for fetching the tile B′1 of matrix B are calculated as (B+16N), (B+17N), (B+18N), . . . , (B+31N)—e.g., wherein the address values to use for fetching the tile B′2 of matrix B are calculated as (B+64+16N), (B+64+17N), . . . , (B+64+31N).

To facilitate the addressing of individual rows of a given tile, some embodiments detect, register, and/or search fetch pattern information (such as that provided at repository 122 or fetch pattern registry 330) which, for a given tile, identifies both an intra-tile stride and one or more inter-tile strides. Various embodiments additionally or alternatively use one such intra-tile stride, and one such inter-tile strides, to generate micro-operations to prefetch tiles of a given matrix.

In various embodiments, tile prefetch functionality includes or is otherwise based on the registration of a tile fetch pattern, and/or the issuing of one or more tile prefetches based on the detection of a later tile fetch as confirming to the registered tile fetch pattern. To facilitate such functionality, some embodiments variously provide and/or utilize two data structures (e.g., tables), referred to herein as a “fetch pattern table” and a “prefetch stream table”.

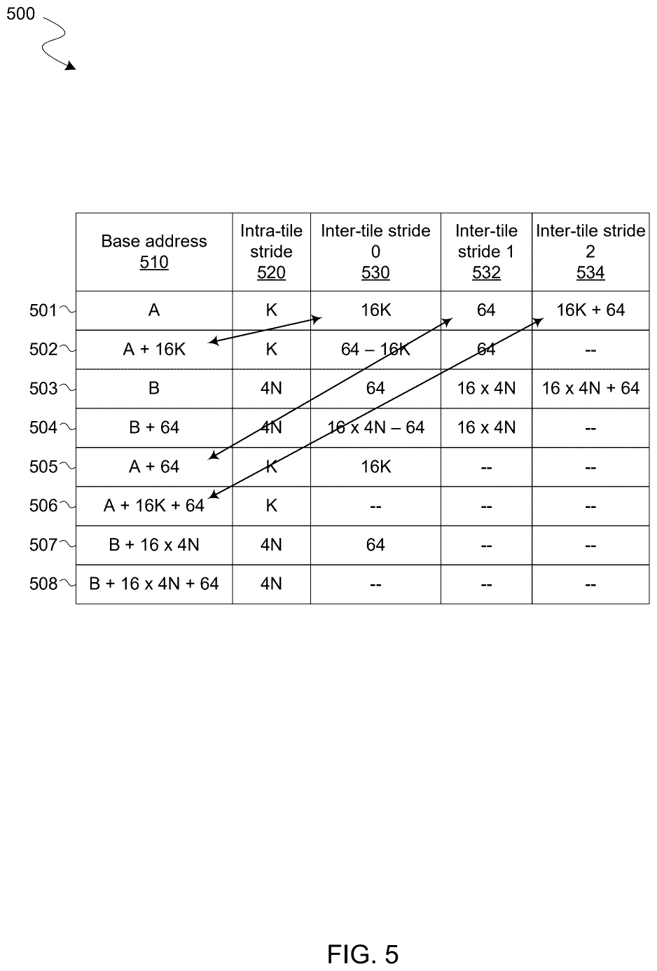

FIG. 5 shows one example format of a fetch pattern table 500 which is to provide various types of stride information according to an embodiment. Fetch pattern table 500 demonstrates one embodiment wherein fetch pattern information is registered and made available as a reference for identifying an opportunity (if any) to perform a tile prefetching. Information such as that which is provided at fetch pattern table 500 is communicated, calculated and/or otherwise determined (for example) with prefetch unit 120 or prefetch unit 310—e.g., wherein fetch pattern registry 330 includes fetch pattern table 500. In some embodiments, operations of method 200 are based on (for example, include), or result in, a communication of such information.

Entries of fetch pattern table 500 each correspond to a different respective demand fetch instruction (such as a tileload instruction, for example) to cache or otherwise load tile data. As shown in FIG. 5, a given one such entry of fetch pattern table 500 comprises a field 510 which is to provide an identifier (in this example embodiment, a base address) of an instruction to which the entry in question corresponds. In various embodiments, the entry additionally or alternatively comprises a field (not shown) to provide an instruction pointer value as an identifier of the instruction.

In some embodiments, the given entry of fetch pattern table 500 further comprises a field 520 to provide a value which identifies an intra-tile stride—e.g., a stride between two successive data portions of the same tile which is targeted by the instruction to which the entry in question corresponds. The intra-tile stride is explicitly identified, for example, by an operand of the instruction to which said entry corresponds.

In one such embodiment, the given entry of fetch pattern table 500 further comprises one or more fields which are each to identify a respective inter-tile stride. For example, each such entry specifies a stride between tile data (of one matrix) which is to be accessed by the instruction to which that entry corresponds, and tile data (of a different matrix) which is to be accessed by another instruction to which a different entry of fetch pattern table 500 corresponds. By way of illustration and not limitation, prefetch unit 120, prefetch unit 310 or other suitable logic provides functionality to detect (e.g., at detector 320) that two demand fetch instructions target different respective tiles of the same matrix, and to determine a difference between the respective base addresses indicated by said demand fetch instructions.

In the example embodiment shown, a given entry of fetch pattern table 500 comprises an inter-tile stride 0 field 530 to identify a first stride between a corresponding demand fetch instruction and a respective next subsequent demand fetch instruction in the same fetch stream. Furthermore, the given entry of fetch pattern table 500 comprises an inter-tile stride 1 field 532 to identify a second stride between the corresponding demand fetch instruction and a respective second subsequent demand fetch instruction in the same fetch stream. Further still, said entry of fetch pattern table 500 comprises an inter-tile stride 2 field 534 to identify a third stride between the corresponding demand fetch instruction and a respective third subsequent demand fetch instruction in the same fetch stream.

The particular number and order of fields 510, 520, 530, 532, 534 is merely illustrative, and not limiting on some embodiments. For example, in various other embodiments, fetch pattern table 500 includes fewer, or more, inter-tile stride fields. In some embodiments, fetch pattern table 500 further comprises any of various other fields (not shown) to facilitate the communication and/or use of information which facilitates the identification of a tile fetch pattern. In one such embodiment, an entry of fetch pattern table 500 further comprises a field (not shown) which identifies a total number of rows in a given tile of the matrix.

In an illustrative scenario according to one embodiment, an entry 501 of fetch pattern table 500 corresponds to a first instruction to fetch a first tile of a first matrix—e.g., wherein an entry 502 corresponds to a second instruction to fetch a second tile of the first matrix, and wherein another entry 503 corresponds to a third instruction to fetch a first tile of a second matrix. Furthermore, an entry 504 of fetch pattern table 500 corresponds to a fourth instruction to fetch a second tile of the second matrix—e.g., wherein an entry 505 corresponds to a fifth instruction to fetch a third tile of the first matrix, and wherein another entry 506 corresponds to a sixth instruction to fetch a fourth tile of the first matrix. Further still, an entry 507 of fetch pattern table 500 corresponds to a seventh instruction to fetch a third tile of the second matrix, wherein another entry 508 corresponds to an eighth instruction to fetch a fourth tile of the second matrix

In one such embodiment, the value of the inter-tile stride 0 field 530 in entry 501 is provided based on a determination—e.g., by detector 320—that the first instruction and the second instruction (corresponding to entries 501, 502, respectively) target different respective tiles of the first matrix. For example, the value is equal to a difference between the respective base addresses indicated by the first instruction and the second instruction. Furthermore, the value of the inter-tile stride 1 field 532 in entry 501 is similarly provided based on a determination that the first instruction and the fifth instruction (corresponding to entries 501, 505, respectively) target different respective tiles of the first matrix. Further still, the value of the inter-tile stride 2 field 534 in entry 501 is similarly provided based on a determination that the first instruction and the sixth instruction (corresponding to entries 501, 506, respectively) target different respective tiles of the first matrix.

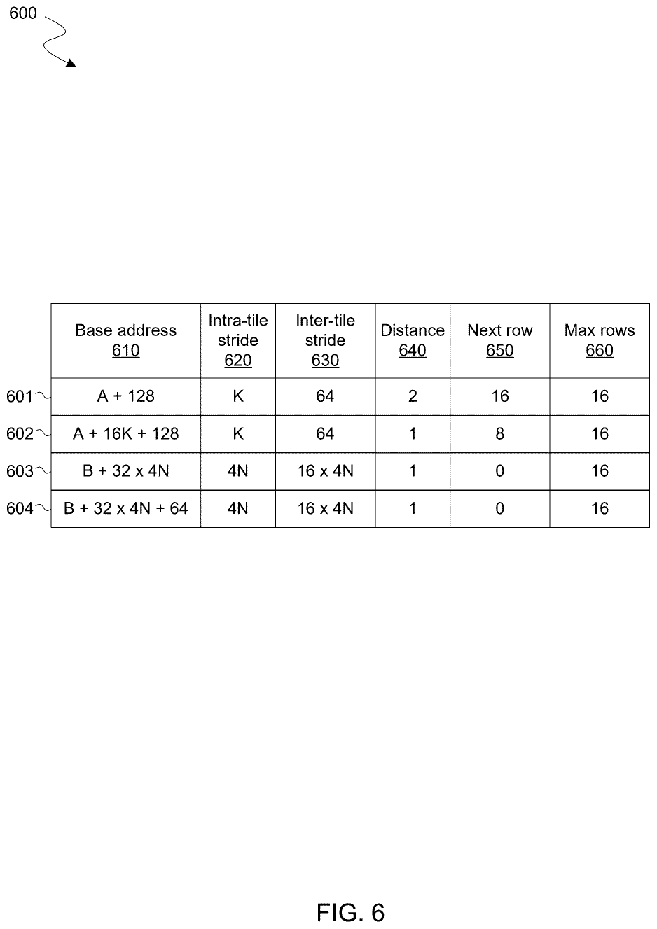

FIG. 6 shows a format of a prefetch stream table 600 to facilitate an identification of prefetch operations that are to be performed according to an embodiment. Prefetch stream table 600 illustrates a registry of tile prefetches which are to be (and, in some embodiments, have been) generated based on stride information such as that provided with fetch pattern table 500. For example, prefetch stream table 600 is provided at prefetch unit 120 or prefetch unit 310—e.g., wherein prefetch registry 342 includes prefetch stream table 600. In some embodiments, operations of method 200 access, or are otherwise based on, prefetch stream table 600.

In an embodiment, entries of prefetch stream table 600 each correspond to a respective tile prefetch stream which is to be implemented, and/or is currently being implemented. For example, a given one such entry specifies or otherwise indicates one or more micro-operations which are to be provided to perform one or more prefetches of the corresponding tile prefetch stream. In some embodiments, entries of prefetch stream table 600 each correspond to a different respective one or more matrix tiles (which, in turn, are associated with a respective prefetch stream)—e.g., where some entries correspond to different respective tiles of the same matrix and/or some entries correspond to tiles of different respective matrices.

As shown in FIG. 6, a given entry of prefetch stream table 600 comprises a respective field 610 which is to specify or otherwise indicate a base address to be used in the implementation of one or more prefetches of tile data. Furthermore, such an entry of prefetch stream table 600 comprises a respective field 620 which is to specify or otherwise indicate an intra-tile stride that is to be used in the implementation data prefetches for a corresponding one or more tiles. Further still, such an entry of prefetch stream table 600 comprises a respective field 630 which is to specify or otherwise indicate an inter-tile stride between two tiles for which data is to be prefetched.

In an illustrative scenario according to one embodiment, prefetch stream table 600 comprises an entry 601 which identifies characteristics of prefetches that are to target first tiles of a first matrix. Furthermore, an entry 602 of prefetch stream table 600 identifies characteristics of prefetches that are to target second tiles of the first matrix. Alternatively or in addition, an entry 603 of prefetch stream table 600 identifies characteristics of prefetches that are to target third tiles of a second matrix. In one such embodiment, another entry 604 of prefetch stream table 600 identifies characteristics of prefetches that are to target second tiles of the second matrix. However, the particular entries 601-604 shown are merely illustrative, and prefetch stream table 600 includes any of various additional and/or alternative entries, in other embodiments.

In one example embodiment, entry 601 is generated based on the entry 501 of fetch pattern table 500—e.g., wherein the fields 610, 620, 630 of entry 601 are based, respectively, on the fields 510, 520, 532 of entry 501. Alternatively or in addition, entry 602 is similarly generated based on the entry 502 of fetch pattern table 500—e.g., wherein the fields 610, 620, 630 of entry 602 are based, respectively, on the fields 510, 520, 532 of entry 502. Alternatively or in addition, entry 603 is similarly generated based on the entry 503 of fetch pattern table 500—e.g., wherein entry 604 is generated based on the entry 504 of fetch pattern table 500.

In various embodiments, a given entry of prefetch stream table 600 is a basis for, or is otherwise indicative of, a prefetcher generating a first one or more micro-operations to load multiple portions of one tile of a matrix. In one such embodiment, said given entry of prefetch stream table 600 is also a basis for, or is otherwise indicative of, the prefetcher generating a second one or more micro-operations to subsequently load multiple portions of a different tile of that same matrix. In some embodiments, said given entry of prefetch stream table 600 is updated, during a period of time in which data of a matrix is prefetched, to facilitate the subsequent generation of micro-operations for prefetching of additional data of the matrix.

In various embodiments, a given entry of prefetch stream table 600 includes (or is otherwise used in combination with) additional reference information which facilitates such generation of micro-operations to prefetch tile data. By way of illustration and not limitation, a given entry of prefetch stream table 600 further comprises some or all of a distance field 640, a next row field 650, and a maximum rows field 660. However, it is to be noted that, in other embodiments, entries of prefetch stream table 600 omit some or all of fields 640, 650, 660, and/or include one or more other fields to facilitate the prefetching of tile data.

In an embodiment, the field 640 of a given entry of prefetch stream table 600 is to specify or otherwise indicate how far a prefetcher has already prefetched from a base address which, at least at one point, was indicated in the respective field 610 of said entry. Furthermore, the field 650 of such an entry of prefetch stream table 600 is to specify or otherwise indicate, for a tile which is currently a target of the prefetching indicated by the entry in question, a number of rows of the tile (if any) which remain to be prefetched. Further still, the field 660 of such an entry of prefetch stream table 600 is to specify or otherwise indicate a maximum number of rows in the tile which is currently the target of the prefetching indicated by the entry in question.

In various embodiments, a given entry of prefetch stream table 600 is created based on a prefetcher (e.g., prefetch unit 120 or prefetch unit 310) detecting that one or more demand fetch instructions—e.g., including tileload instructions—conform to a fetch pattern which was previously-registered (at fetch pattern registry 330 or fetch pattern table 500, for example). In an illustrative scenario according to one embodiment, creation of the given entry of prefetch stream table 600 includes setting the field 610 of the given entry to be equal to a base address in a most recent demand fetch instruction which conforms to the pattern. In some embodiments, the creation further comprises initializing the distance value in field 640 to one (1), and initializing the next row value in field 650 to zero (0).

For a given entry of prefetch stream table 600, the base address in field 610 is subject to being updated based on the detection of some later demand fetch instruction (if any) which conforms to the same fetch patterns. In some embodiments, such detection and updating of field 610 also results in the field 640 being updated to indicate that the corresponding distance is reduced—e.g., based on a difference between the previous base address value and the updated base address value. For example, the distance value in field 640 is reduced by an amount which is equal to the address difference divided by the inter-tile stride value in field 630.

In an embodiment, a prefetcher issues prefetches for p cache lines at a time, where p is some positive integer that, for example, is a configurable parameter. Subsequently, the prefetcher issues additional prefetches when it is determined, for example, that there are p free entries available in a prefetch queue. In some embodiments, to issue new prefetches to such a prefetch queue, the prefetcher selects an entry from among multiple entries of prefetch stream table 600—e.g., where the selection is based on the respective distance fields 640 of said multiple entries.

By way of illustration and not limitation, the prefetcher selects an entry for a stream which, relative to some or all other current streams, has a lowest distance and—if one or more other streams have that same distance—has a lowest next row field. In one such embodiment, if the next row field 650 of the selected entry is lower than the maximum rows field 660 of that selected entry, the next p rows of the corresponding tile are prefetched (based on the intra-tile stride indicated in field 620) and the next row field 650 of the selected entry is incremented by p. If, however, the next row field 650 of the selected entry equals the maximum rows field 660 of that selected entry, the prefetcher instead increments the distance field 640 of the selected entry, and sets the next row field 650 to p after issuing p prefetches for the next tile (based on the inter-tile stride indicated in field 630). In one such embodiment, a prefetch address is calculated as a sum of the last seen base address (in field 610, for example), a first value which is a product of the distance and the inter-tile stride (in fields 640, 630, respectively), and a second value which is a product of the next row value and the intra-tile stride (in fields 650 and 620, respectively).

Where it is determined that the configured maximum distance is reached, no more prefetches are done until there is a base address update. If there are no updates for a while, a determination is made by the prefetcher that the stream in question has ended, and that the corresponding entry of prefetch stream table 600 can be evicted, invalidated, or the like.

In some embodiments, a given entry of prefetch stream table 600 comprises two or more distance fields—e.g., where one such field is specific to (pre)fetching to a first cache (e.g., an L1 cache) and another such field is specific to (pre)fetching to different cache (e.g., an L2 cache). Such embodiments enable a relatively more aggressive prefetching to a lower level cache (such as an L2 cache or even to an LLC), for example.

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

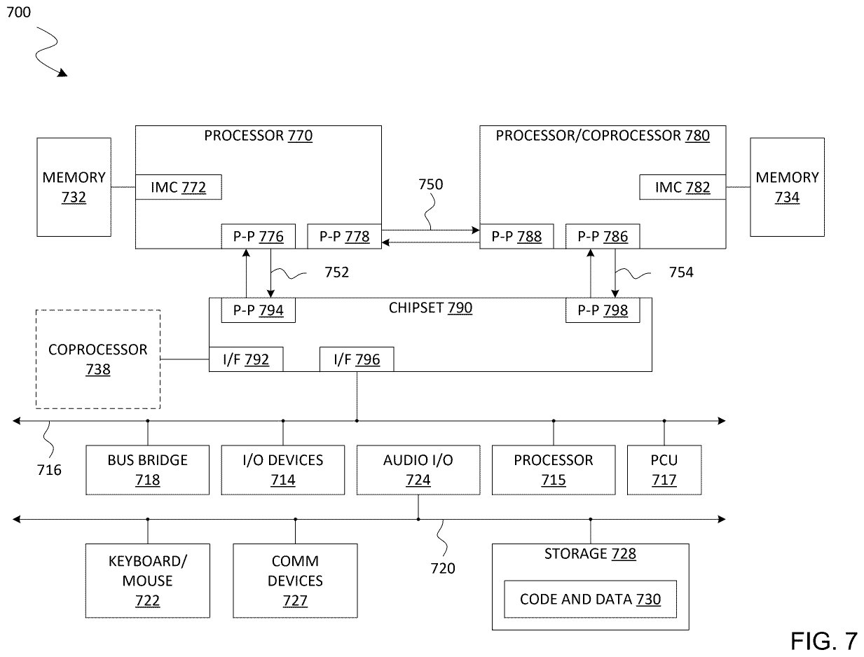

FIG. 7 illustrates an exemplary system. Multiprocessor system 700 is a point-to-point interconnect system and includes a plurality of processors including a first processor 770 and a second processor 780 coupled via a point-to-point interconnect 750. In some examples, the first processor 770 and the second processor 780 are homogeneous. In some examples, first processor 770 and the second processor 780 are heterogenous. Though the exemplary system 700 is shown to have two processors, the system may have three or more processors, or may be a single processor system.

Processors 770 and 780 are shown including integrated memory controller (IMC) circuitry 772 and 782, respectively. Processor 770 also includes as part of its interconnect controller point-to-point (P-P) interfaces 776 and 778; similarly, second processor 780 includes P-P interfaces 786 and 788. Processors 770, 780 may exchange information via the point-to-point (P-P) interconnect 750 using P-P interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a chipset 790 via individual P-P interconnects 752, 754 using point to point interface circuits 776, 794, 786, 798. Chipset 790 may optionally exchange information with a coprocessor 738 via an interface 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via P-P interconnect, such that either or both processors' local cache information may be stored in the shared cache if a processor is placed into a low power mode.

Chipset 790 may be coupled to a first interconnect 716 via an interface 796. In some examples, first interconnect 716 may be a Peripheral Component Interconnect (PCI) interconnect, or an interconnect such as a PCI Express interconnect or another I/O interconnect. In some examples, one of the interconnects couples to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interconnect 716, along with a bus bridge 718 which couples first interconnect 716 to a second interconnect 720. In some examples, one or more additional processor(s) 715, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 716. In some examples, second interconnect 720 may be a low pin count (LPC) interconnect. Various devices may be coupled to second interconnect 720 including, for example, a keyboard and/or mouse 722, communication devices 727 and a storage circuitry 728. Storage circuitry 728 may be one or more non-transitory machine-readable storage media as described below, such as a disk drive or other mass storage device which may include instructions/code and data 730 in some examples. Further, an audio I/O 724 may be coupled to second interconnect 720. Note that other architectures than the point-to-point architecture described above are possible. For example, instead of the point-to-point architecture, a system such as multiprocessor system 700 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

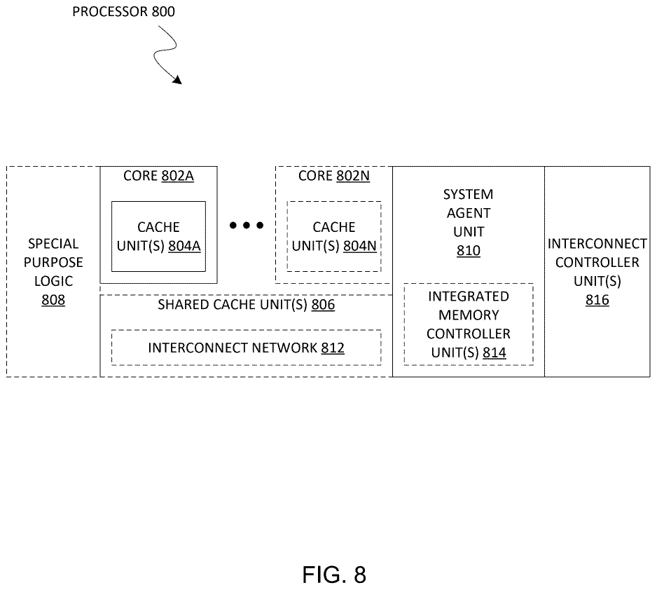

FIG. 8 illustrates a block diagram of an example processor 800 that may have more than one core and an integrated memory controller. The solid lined boxes illustrate a processor 800 with a single core 802A, a system agent unit circuitry 810, a set of one or more interconnect controller unit(s) circuitry 816, while the optional addition of the dashed lined boxes illustrates an alternative processor 800 with multiple cores 802A-N, a set of one or more integrated memory controller unit(s) circuitry 814 in the system agent unit circuitry 810, and special purpose logic 808, as well as a set of one or more interconnect controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802A-N being one or more general purpose cores (e.g., general purpose in-order cores, general purpose out-of-order cores, or a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804A-N within the cores 802A-N, a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples ring-based interconnect network circuitry 812 interconnects the special purpose logic 808 (e.g., integrated graphics logic), the set of shared cache unit(s) circuitry 806, and the system agent unit circuitry 810, alternative examples use any number of well-known techniques for interconnecting such units. In some examples, coherency is maintained between one or more of the shared cache unit(s) circuitry 806 and cores 802A-N.

In some examples, one or more of the cores 802A-N are capable of multi-threading. The system agent unit circuitry 810 includes those components coordinating and operating cores 802A-N. The system agent unit circuitry 810 may include, for example, power control unit (PCU) circuitry and/or display unit circuitry (not shown). The PCU may be or may include logic and components needed for regulating the power state of the cores 802A-N and/or the special purpose logic 808 (e.g., integrated graphics logic). The display unit circuitry is for driving one or more externally connected displays.

The cores 802A-N may be homogenous in terms of instruction set architecture (ISA). Alternatively, the cores 802A-N may be heterogeneous in terms of ISA; that is, a subset of the cores 802A-N may be capable of executing an ISA, while other cores may be capable of executing only a subset of that ISA or another ISA.

### Exemplary Core Architectures-in-Order and Out-of-Order Core Block Diagram

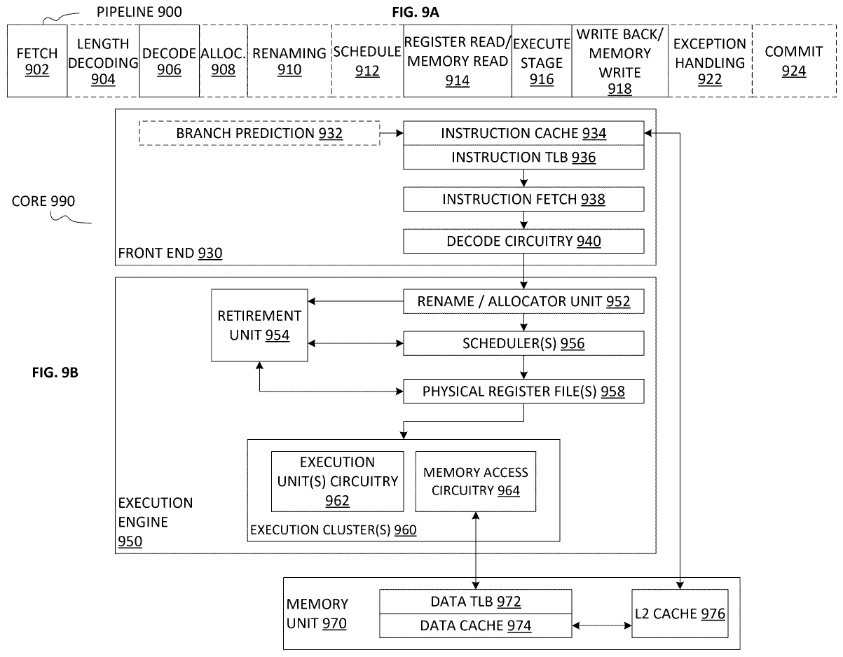

FIG. 9A is a block diagram illustrating both an exemplary in-order pipeline and an exemplary register renaming, out-of-order issue/execution pipeline according to examples. FIG. 9B is a block diagram illustrating both an exemplary example of an in-order architecture core and an exemplary register renaming, out-of-order issue/execution architecture core to be included in a processor according to examples. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 9B may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9B shows a processor core 990 including front-end unit circuitry 930 coupled to an execution engine unit circuitry 950, and both are coupled to a memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit circuitry 930 may include branch prediction circuitry 932 coupled to an instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to a retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, arithmetic generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to a data cache circuitry 974 coupled to a level 2 (L2) cache circuitry 976. In one exemplary example, the memory access circuitry 964 may include a load unit circuitry, a store address unit circuit, and a store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, a level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

### Exemplary Execution Unit(s) Circuitry

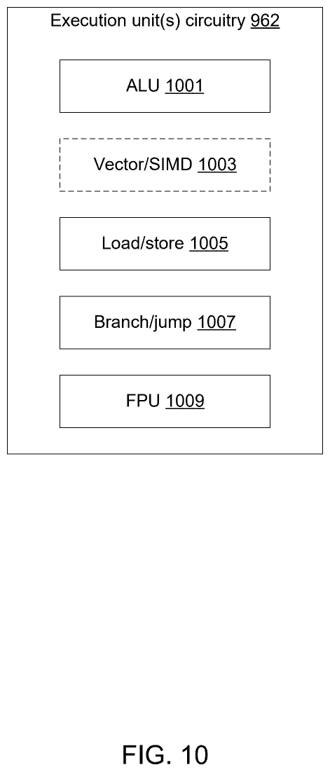

FIG. 10 illustrates examples of execution unit(s) circuitry, such as execution unit(s) circuitry 962 of FIG. 9B. As illustrated, execution unit(s) circuity 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

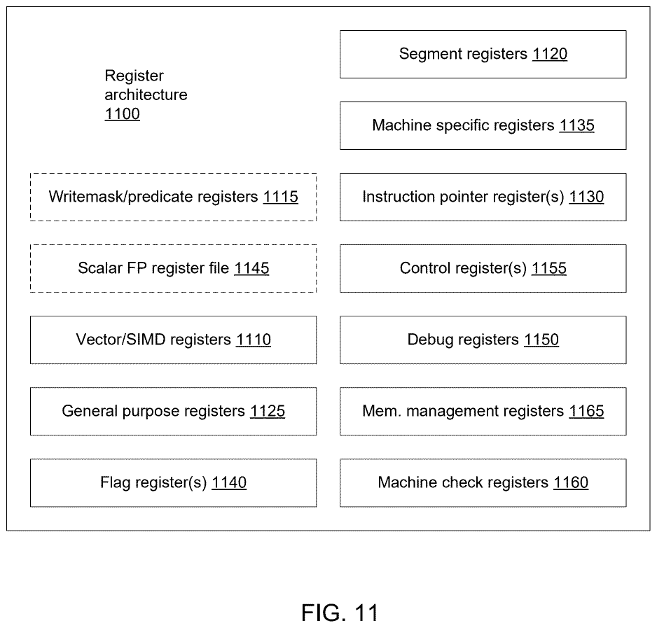

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consists of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 1120 contain segment points for use in accessing memory. In some examples, these registers are referenced by the names CS, DS, SS, ES, FS, and GS.

Machine specific registers (MSRs) 1135 control and report on processor performance. Most MSRs 1135 handle system-related functions and are not accessible to an application program. Machine check registers 1160 consist of control, status, and error reporting MSRs that are used to detect and report on hardware errors.

One or more instruction pointer register(s) 1130 store an instruction pointer value. Control register(s) 1155 (e.g., CR0-CR4) determine the operating mode of a processor (e.g., processor 770, 780, 738, 715, and/or 800) and the characteristics of a currently executing task. Debug registers 1150 control and allow for the monitoring of a processor or core's debugging operations.

Memory (mem) management registers 1165 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1100 may, for example, be used in physical register file(s) circuitry 9 58.

Techniques and architectures for prefetching data are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, a processor comprises first circuitry to detect one or more events wherein multiple demand fetch instructions each fetch a different respective tile of a matrix, provide fetch pattern information at a registry based on the one or more events, the fetch pattern information to correspond to a first demand fetch instruction of the multiple demand fetch instructions, wherein the fetch pattern information is to identify both an intra-tile stride and an inter-tile stride, and detect, after the one or more events, that a second demand fetch instruction is to fetch a first tile of the matrix, and second circuitry coupled to the first circuitry, the second circuitry to perform an access of the registry, based on the second demand fetch instruction, to identify the intra-tile stride and the inter-tile stride, and generate one or more microoperations based on the access, wherein the one or more microoperations are to prefetch one or more tiles of the matrix.

In one or more second embodiments, further to the first embodiment, the fetch pattern information is provided at an entry of the registry, a first field of the entry is to identify the intra-tile stride based on an operand of the first demand fetch instruction, and a second field of the entry is to identify the inter-tile stride based on respective base addresses of the first demand fetch instruction and another of the multiple demand fetch instructions.

In one or more third embodiments, further to the second embodiment, the inter-tile stride is a first inter-tile stride, and a third field of the entry is to identify a second inter-tile stride based on respective base addresses of the first demand fetch instruction and a third demand fetch instruction of the multiple demand fetch instructions.

In one or more fourth embodiments, further to the second embodiment, a third field of the entry is to identify an instruction pointer value which is based on the first demand fetch instruction.

In one or more fifth embodiments, further to the first embodiment or the second embodiment, the registry is a first registry, and the second circuitry to generate the one or more microoperations based on the access comprises the second circuitry to provide stream information at a second registry based on the access, wherein the stream information is to correspond to the one or more tiles of the matrix, and wherein the stream information is to comprise the intra-tile stride and the inter-tile stride, and generate the one or more microoperations based on the stream information.

In one or more sixth embodiments, further to the fifth embodiment, the second circuitry is to provide the stream information at an entry of the second registry, and the second circuitry further to detect that a third demand fetch instruction, which is subsequent to the first demand fetch instruction, targets data of the one or more tiles, and based on the third demand fetch instruction, update the entry to replace a first base address with a second base address.

In one or more seventh embodiments, further to the sixth embodiment, a field of the entry is to identify a maximum number of rows of a tile which is currently a target of a stream to which the entry corresponds.

In one or more eighth embodiments, further to the sixth embodiment, a field of the entry is to indicate, for a tile which is currently a target of a stream to which the entry corresponds, a number of rows of the tile which remain to be prefetched.

In one or more ninth embodiments, further to the sixth embodiment, a field of the entry is to indicate a distance, relative to a location indicated by a base address, from which tile data has already been prefetched.

In one or more tenth embodiments, a method comprises detecting one or more events wherein multiple demand fetch instructions each target a different respective tile of a matrix, based on the one or more events, providing at a registry fetch pattern information which corresponds to a first demand fetch instruction of the multiple demand fetch instructions, wherein the fetch pattern information identifies both an intra-tile stride and an inter-tile stride, after detecting the one or more events, detecting that a second demand fetch instruction is to fetch a first tile of the matrix, performing an access of the registry, based on the second demand fetch instruction, to identify the intra-tile stride and the inter-tile stride, and based on the access, generating one or more microoperations to prefetch one or more tiles of the matrix.

In one or more eleventh embodiments, further to the tenth embodiment, the fetch pattern information is provided at an entry of the registry, a first field of the entry identifies the intra-tile stride based on an operand of the first demand fetch instruction, and a second field of the entry identifies the inter-tile stride based on respective base addresses of the first demand fetch instruction and another of the multiple demand fetch instructions.

In one or more twelfth embodiments, further to the eleventh embodiment, the inter-tile stride is a first inter-tile stride, and a third field of the entry identifies a second inter-tile stride based on respective base addresses of the first demand fetch instruction and a third demand fetch instruction of the multiple demand fetch instructions.

In one or more thirteenth embodiments, further to the eleventh embodiment, a third field of the entry identifies an instruction pointer value which is based on the first demand fetch instruction.

In one or more fourteenth embodiments, further to the tenth embodiment or the eleventh embodiment, the registry is a first registry, and generating the one or more microoperations based on the access comprises based on the access, providing at a second registry stream information which corresponds to the one or more tiles of the matrix, the stream information comprising the intra-tile stride and the inter-tile stride, and generating the one or more microoperations based on the stream information.

In one or more fifteenth embodiments, further to the fourteenth embodiment, the stream information is provided at an entry of the second registry, and the method further comprises detecting that a third demand fetch instruction, which is subsequent to the first demand fetch instruction, targets data of the one or more tiles, and based on the third demand fetch instruction, updating the entry to replace a first base address with a second base address.

In one or more sixteenth embodiments, further to the fifteenth embodiment, a field of the entry identifies a maximum number of rows of a tile which is currently a target of a stream to which the entry corresponds.

In one or more seventeenth embodiments, further to the fifteenth embodiment, a field of the entry indicates, for a tile which is currently a target of a stream to which the entry corresponds, a number of rows of the tile which remain to be prefetched.

In one or more eighteenth embodiments, further to the fifteenth embodiment, a field of the entry indicates a distance, relative to a location indicated by a base address, from which tile data has already been prefetched.

In one or more nineteenth embodiments, a system comprises a memory, and a processor coupled to the memory, the processor comprising first circuitry to detect one or more events wherein multiple demand fetch instructions each fetch a different respective tile of a matrix, provide fetch pattern information at a registry based on the one or more events, the fetch pattern information to correspond to a first demand fetch instruction of the multiple demand fetch instructions, wherein the fetch pattern information is to identify both an intra-tile stride and an inter-tile stride, and detect, after the one or more events, that a second demand fetch instruction is to fetch a first tile of the matrix, and second circuitry coupled to the first circuitry, the second circuitry to perform an access of the registry, based on the second demand fetch instruction, to identify the intra-tile stride and the inter-tile stride, and generate one or more microoperations based on the access, wherein the one or more microoperations are to prefetch one or more tiles of the matrix.

In one or more twentieth embodiments, further to the nineteenth embodiment, the fetch pattern information is provided at an entry of the registry, a first field of the entry is to identify the intra-tile stride based on an operand of the first demand fetch instruction, and a second field of the entry is to identify the inter-tile stride based on respective base addresses of the first demand fetch instruction and another of the multiple demand fetch instructions.

In one or more twenty-first embodiments, further to the twentieth embodiment, the inter-tile stride is a first inter-tile stride, and a third field of the entry is to identify a second inter-tile stride based on respective base addresses of the first demand fetch instruction and a third demand fetch instruction of the multiple demand fetch instructions.

In one or more twenty-second embodiments, further to the twentieth embodiment, a third field of the entry is to identify an instruction pointer value which is based on the first demand fetch instruction.

In one or more twenty-third embodiments, further to the nineteenth embodiment or the twentieth embodiment, the registry is a first registry, and the second circuitry to generate the one or more microoperations based on the access comprises the second circuitry to provide stream information at a second registry based on the access, wherein the stream information is to correspond to the one or more tiles of the matrix, and wherein the stream information is to comprise the intra-tile stride and the inter-tile stride, and generate the one or more microoperations based on the stream information.

In one or more twenty-fourth embodiments, further to the twenty-third embodiment, the second circuitry is to provide the stream information at an entry of the second registry, and the second circuitry further to detect that a third demand fetch instruction, which is subsequent to the first demand fetch instruction, targets data of the one or more tiles, and based on the third demand fetch instruction, update the entry to replace a first base address with a second base address.

In one or more twenty-fifth embodiments, further to the twenty-fourth embodiment, a field of the entry is to identify a maximum number of rows of a tile which is currently a target of a stream to which the entry corresponds.

In one or more twenty-sixth embodiments, further to the twenty-fourth embodiment, a field of the entry is to indicate, for a tile which is currently a target of a stream to which the entry corresponds, a number of rows of the tile which remain to be prefetched.

In one or more twenty-seventh embodiments, further to the twenty-fourth embodiment, a field of the entry is to indicate a distance, relative to a location indicated by a base address, from which tile data has already been prefetched.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
first circuitry to:
detect one or more events wherein multiple demand fetch instructions each fetch a different respective tile of a matrix;
provide fetch pattern information at a registry based on the one or more events, the fetch pattern information to correspond to a first demand fetch instruction of the multiple demand fetch instructions, wherein the fetch pattern information is to identify both an intra-tile stride and an inter-tile stride; and
detect, after the one or more events, that a second demand fetch instruction is to fetch a first tile of the matrix; and
second circuitry coupled to the first circuitry, the second circuitry to:
perform an access of the registry, based on the second demand fetch instruction, to identify the intra-tile stride and the inter-tile stride; and
generate one or more microoperations based on the access, wherein the one or more microoperations are to prefetch one or more tiles of the matrix.

2. The processor of claim 1, wherein:
the fetch pattern information is provided at an entry of the registry;
a first field of the entry is to identify the intra-tile stride based on an operand of the first demand fetch instruction; and
a second field of the entry is to identify the inter-tile stride based on respective base addresses of the first demand fetch instruction and another of the multiple demand fetch instructions.

3. The processor of claim 2, wherein:
the inter-tile stride is a first inter-tile stride; and
a third field of the entry is to identify a second inter-tile stride based on respective base addresses of the first demand fetch instruction and a third demand fetch instruction of the multiple demand fetch instructions.

4. The processor of claim 1, wherein:
the registry is a first registry; and
the second circuitry to generate the one or more microoperations based on the access comprises the second circuitry to:
provide stream information at a second registry based on the access, wherein the stream information is to correspond to the one or more tiles of the matrix, and wherein the stream information is to comprise the intra-tile stride and the inter-tile stride; and
generate the one or more microoperations based on the stream information.

5. The processor of claim 4, wherein:
the second circuitry is to provide the stream information at an entry of the second registry; and
the second circuitry further to:
detect that a third demand fetch instruction, which is subsequent to the first demand fetch instruction, targets data of the one or more tiles; and
based on the third demand fetch instruction, update the entry to replace a first base address with a second base address.

6. The processor of claim 5, wherein a field of the entry is to identify a maximum number of rows of a tile which is currently a target of a stream to which the entry corresponds.

7. The processor of claim 5, wherein a field of the entry is to indicate, for a tile which is currently a target of a stream to which the entry corresponds, a number of rows of the tile which remain to be prefetched.

8. The processor of claim 5, wherein a field of the entry is to indicate a distance, relative to a location indicated by a base address, from which tile data has already been prefetched.

9. A method comprising:
detecting one or more events wherein multiple demand fetch instructions each target a different respective tile of a matrix;
based on the one or more events, providing at a registry fetch pattern information which corresponds to a first demand fetch instruction of the multiple demand fetch instructions, wherein the fetch pattern information identifies both an intra-tile stride and an inter-tile stride;
after detecting the one or more events, detecting that a second demand fetch instruction is to fetch a first tile of the matrix;
performing an access of the registry, based on the second demand fetch instruction, to identify the intra-tile stride and the inter-tile stride; and
based on the access, generating one or more microoperations to prefetch one or more tiles of the matrix.

10. The method of claim 9, wherein:
the fetch pattern information is provided at an entry of the registry;
a first field of the entry identifies the intra-tile stride based on an operand of the first demand fetch instruction; and
a second field of the entry identifies the inter-tile stride based on respective base addresses of the first demand fetch instruction and another of the multiple demand fetch instructions.

11. The method of claim 10, wherein:
the inter-tile stride is a first inter-tile stride; and
a third field of the entry identifies a second inter-tile stride based on respective base addresses of the first demand fetch instruction and a third demand fetch instruction of the multiple demand fetch instructions.

12. The method of claim 9, wherein:
the registry is a first registry; and
generating the one or more microoperations based on the access comprises:
based on the access, providing at a second registry stream information which corresponds to the one or more tiles of the matrix, the stream information comprising the intra-tile stride and the inter-tile stride; and
generating the one or more microoperations based on the stream information.

13. The method of claim 12, wherein:
the stream information is provided at an entry of the second registry; and
the method further comprises:
detecting that a third demand fetch instruction, which is subsequent to the first demand fetch instruction, targets data of the one or more tiles; and
based on the third demand fetch instruction, updating the entry to replace a first base address with a second base address.

14. The method of claim 13, wherein a field of the entry indicates, for a tile which is currently a target of a stream to which the entry corresponds, a number of rows of the tile which remain to be prefetched.

15. A system comprising:
a memory; and
a processor coupled to the memory, the processor comprising:
first circuitry to:
detect one or more events wherein multiple demand fetch instructions each fetch a different respective tile of a matrix;
provide fetch pattern information at a registry based on the one or more events, the fetch pattern information to correspond to a first demand fetch instruction of the multiple demand fetch instructions, wherein the fetch pattern information is to identify both an intra-tile stride and an inter-tile stride; and
detect, after the one or more events, that a second demand fetch instruction is to fetch a first tile of the matrix; and
second circuitry coupled to the first circuitry, the second circuitry to:
perform an access of the registry, based on the second demand fetch instruction, to identify the intra-tile stride and the inter-tile stride; and
generate one or more microoperations based on the access, wherein the one or more microoperations are to prefetch one or more tiles of the matrix.

16. The system of claim 15, wherein:
the fetch pattern information is provided at an entry of the registry;
a first field of the entry is to identify the intra-tile stride based on an operand of the first demand fetch instruction; and
a second field of the entry is to identify the inter-tile stride based on respective base addresses of the first demand fetch instruction and another of the multiple demand fetch instructions.

17. The system of claim 16, wherein:
the inter-tile stride is a first inter-tile stride; and
a third field of the entry is to identify a second inter-tile stride based on respective base addresses of the first demand fetch instruction and a third demand fetch instruction of the multiple demand fetch instructions.

18. The system of claim 15, wherein:
the registry is a first registry; and
the second circuitry to generate the one or more microoperations based on the access comprises the second circuitry to:
provide stream information at a second registry based on the access, wherein the stream information is to correspond to the one or more tiles of the matrix, and wherein the stream information is to comprise the intra-tile stride and the inter-tile stride; and
generate the one or more microoperations based on the stream information.

19. The system of claim 18, wherein:
the second circuitry is to provide the stream information at an entry of the second registry; and
the second circuitry further to:
detect that a third demand fetch instruction, which is subsequent to the first demand fetch instruction, targets data of the one or more tiles; and
based on the third demand fetch instruction, update the entry to replace a first base address with a second base address.

20. The system of claim 19, wherein a field of the entry is to indicate, for a tile which is currently a target of a stream to which the entry corresponds, a number of rows of the tile which remain to be prefetched.
